(19) United States
(12) Patent Application Publication
(10) Pub. No.: US 2024/0159275 A1
(43) Pub. Date: May 16, 2024

(54) MAIN BEARING ASSEMBLY FOR A WIND TURBINE

(71) Applicant: Schaeffler Technologies AG & Co. KG, Herzogenaurach (DE)

(72) Inventors: Andreas Mangold, Mellrichstadt (DE); Wolfgang Losert, Nurnberg (DE); Marc Reichhart, Furth (DE)

(73) Assignee: Schaeffler Technologies AG & Co. KG, Herzogenaurach (DE)

(21) Appl. No.: 18/282,261

(22) PCT Filed: Feb. 18, 2022
(86) PCT No.: PCT/DE2022/100132

§ 371 Date: Sep. 15, 2023

(30) Foreign Application Priority Data
Mar. 18, 2021 (DE) 102021106616.6

(51) Int. Cl. F16C 35/067

(52) U.S. Cl. CPC F16C 35/067; F16C 2360/31

(57) ABSTRACT

A main bearing assembly for a wind turbine, which extends along an axis of rotation and has a main bearing unit having a bearing housing, the bearing unit being designed for fastening to an open machine support. The bearing housing is rotationally symmetrical and at least one fastening foot is provided, which is designed as a component which is independent of the bearing housing and is fastened to the bearing housing, and in the installed state the main bearing unit is fastened to the machine support with the aid of the at least one fastening foot.

### CROSS-REFERENCE TO RELATED APPLICATIONS

This application is the U.S. National Phase of PCT Appln. No. PCT/DE2022/100132, filed Feb. 18, 2022, which claims the benefit of German Patent Appln. No. 102021106616.6, filed Mar. 18, 2021, the entire disclosures of which are incorporated by reference herein.

### TECHNICAL FIELD

The disclosure relates to a main bearing assembly for a wind turbine, wherein the main bearing assembly extends along an axis of rotation and has a main bearing unit having a bearing housing, which is designed for fastening to an open machine support.

### BACKGROUND

Such a main bearing assembly can be found, for example, in WO 2020/169762A1. Further main bearing assemblies can be found, for example, in EP 29 47 339 B1 and EP 2 710 271 B1.

In a wind turbine, a main bearing unit is used to support a rotor shaft, which is also referred to as a rotor. A rotor hub is fastened to this rotor, to which in turn rotor blades are fastened. The main bearing assembly is typically arranged in a machine housing which is fastened to a tower. The machine housing is also referred to as a gondola.

Such a main bearing unit is a bearing with bearing diameters typically greater than 0.5 m. They are used, for example, in wind turbines with an electrical output of several 100 kW and in particular, for example, in wind turbines in a power class between 1 MW and 5 MW. In these systems, the main bearing unit has a diameter of several meters, for example in the range from 1 m to 3.5 m, and is also several meters long. Modern wind turbines are several hundred meters high and the rotor blades are correspondingly long. Overall, high forces act on the main bearing unit during operation, which forces must be absorbed. For this purpose, the main bearing unit is fastened to what is termed a machine support. For reliable power transmission to the machine support, there are special requirements for the fastening of the main bearing unit to the machine support.

According to a known embodiment variant, the machine support is designed as a closed machine support, which completely surrounds the main bearing unit on the peripheral side. The main bearing unit, which is rotationally symmetrical in this case, is bolted to the closed machine support via an annular flange. This configuration has the disadvantage that the machine support is expensive to produce and is also relatively large and therefore heavy. This variant also has a poor ease of assembly of the main bearing unit. In addition, an exact adjustment of the machine support to the main bearing unit is required. By contrast, the main bearing unit itself is designed in a comparatively simple manner as a rotationally symmetrical container.

An alternative embodiment, as can be gathered from WO 2020/169762A1 mentioned at the outset, provides that a bearing housing of the main bearing unit itself is provided with a laterally protruding fastening flange, with which fastening to what is termed an open machine support takes place. An open machine support is understood to mean a machine support which—unlike in the closed form—does not encompass the main bearing unit, and on which the main bearing unit is placed from above. For example, the machine support is flat in the form of a plate, or alternatively, it has a recess for the rotor with support surfaces on the edge, on which the fastening flanges rest and there are screwed to the machine support. This leads to a comparatively complex geometry and structure of the bearing housing, which leads to uneven rigidity, high manufacturing costs, and high weight. In addition, the bearing housing must be adapted to the specific installation situation. The advantage of this variant is easy assembly and a simply constructed, compact, and light machine support.

### SUMMARY

Proceeding therefrom, the disclosure is based on the object of enabling an improved fastening of a main bearing unit to a machine support.

The object is achieved according to the disclosure by a main bearing assembly for a wind turbine, wherein the main bearing assembly extends along an axis of rotation and has a main bearing unit having a bearing housing. The main bearing unit is designed for fastening to a fastening side of an open and therefore simply constructed machine support. To achieve the simplest possible design of the main bearing unit, the bearing housing is designed to be rotationally symmetrical or at least essentially rotationally symmetrical.

According to a first, preferred variant, at least one fastening foot is provided for reliable fastening, which is designed as a component independent of the bearing housing and is fastened to the bearing housing in the installed state. In the course of assembly, therefore, the at least one fastening foot is fastened to the bearing housing. In the installed state, i.e., in the wind turbine, the main bearing unit is fastened to the machine support using the at least one fastening foot.

According to a second variant, the bearing housing has a flattening, as a result of which a flat fastening surface is defined, with which the bearing housing is then fastened, in particular screwed, to the machine support in the installed state.

These variants combine the advantages of the previous configurations according to the prior art. On the one hand, a simple and light design of the machine support is achieved, since it is designed as an open machine support. On the other hand, a simpler and thus lighter construction of the main bearing unit is achieved through the rotationally symmetrical or at least essentially rotationally symmetrical design thereof. All in all, a compact machine support is therefore combined with a simple bearing housing.

Especially in the case of the preferred variant with the separate design of the fastening base, simple and cost-effective adaptation and thus scaling to different installation situations is enabled.

Rotationally symmetrical is understood to mean that the main bearing unit and specifically the bearing housing does not have any parts that protrude laterally on the circumference in some areas, such as fastening flanges, as parts of the bearing housing. Slight deviations from a strict rotational symmetry are possible, for example through the introduction of fastening holes in a fastening flange or indentations.

The variant with the flattening is considered to be essentially rotationally symmetrical. In this case, too, the bearing housing does not have any fastening flanges projecting laterally beyond the circular diameter thereof.

In both variants, the bearing housing is designed in particular as a tube, which has a constant cross-sectional contour in the longitudinal direction, i.e., the bearing housing when viewed in cross-section is designed, for example, in the shape of a circular ring or as a (one-sided) flattened circular ring over the entire length thereof. In the second variant, the flattening therefore preferably extends over the entire length of the bearing housing.

The wall thickness of the bearing housing can be increased in the area of the flattening so that the largest possible fastening surface can be achieved. On the edge side, the flat fastening surface preferably transitions into a convexly curved outer surface of the bearing housing. Alternatively, the fastening surface—viewed in cross-section perpendicular to the axis of rotation—first transitions into, for example, a vertical or inclined and in particular rectilinear transition surface, which only then transitions into the convexly curved outer surface.

If a main bearing assembly for a wind power plant is discussed here, this is understood to mean the main bearing unit defined at the outset, specifically for wind turbines with a power class greater than 500 kW and in particular in the range between 1 MW and 5 MW. The main bearing unit is installed in such a wind turbine in the installed state.

If an “open” machine support is used here, then this is understood to mean the machine support defined at the outset, which has a fastening side with at least one support surface on which the main bearing unit is supported with the at least one fastening foot. The main bearing unit is therefore placed on the machine support. Specifically, the machine support is designed as a flat machine support with a type of fastening plate on which the main bearing unit is placed.

In addition to the bearing housing, which virtually forms a stator of the main bearing unit, the main bearing unit generally has a rotor, which is typically designed as a hollow shaft. This rotor usually has a rotor flange on the end face, to which in the installed state the rotor hub of the wind turbine with the rotor blades fastened thereto is screwed. The rotor is mounted on the bearing housing via at least one bearing, specifically a roller bearing with roller bodies. Two bearings are preferably arranged to be spaced apart from one another in the direction of the axis of rotation. These are preferably each formed at opposite ends of the bearing housing. A respective bearing typically has an inner ring and an outer ring in addition to the roller bodies. One of these rings faces the rotor and the other of these rings faces the bearing housing. In special design variants, one or both bearing rings can be dispensed with if corresponding running surfaces for the roller bodies are formed on the rotor or on the bearing housing.

The two bearings that are spaced apart from one another are, in particular, offset (tapered roller) bearings, preferably in an O arrangement.

In an expedient embodiment, the at least one fastening foot is fastened to the bearing housing in a reversibly detachable manner and, in particular, is screwed on using a number of screws. Alternatively, it is, for example, materially bonded and undetachable, for example fastened by welding.

The fastening foot preferably has a ring-segment-like fastening flange specifically for the screw fastenings, via which fastening to the bearing housing takes place. The bearing housing correspondingly has, for example, a ring-shaped fastening surface, for example an annular flange, to which the ring-segment-like fastening flange is fastened, in particular screwed. In this case, the screwing takes place in particular in the axial direction.

The fastening flange is curved in a concave manner corresponding to the radius of the bearing housing. It preferably extends over an angular range of at least 90° and preferably up to 180° or even more, for example up to 270°. With an angle range of more than 180°, the bearing housing is shifted along the direction of rotation during assembly. The fastening flange preferably extends over an angular range between 120° and 180°, in particular between 150° and 180°.

In an expedient embodiment, the bearing housing has an annular face at the end, and the fastening flange overlaps this face in the radial direction. Fastening takes place via this face. In the area of this end face, the bearing housing is thickened, for example, with a greater wall thickness. In the case of screw fastening, the screws are inserted at the front, i.e., axially into the end face. The end face can also be formed by an end annular flange.

The bearing housing is therefore encompassed by the overlapping fastening flange in the direction of the axis of rotation and thus also fixed in the axial direction.

In an expedient embodiment, the fastening foot has a ring-segment-like, concavely curved support surface on which the bearing housing rests. The support surface is in turn adapted to the radius of the bearing housing and preferably extends over the same angular range as the fastening flange. The support surface preferably extends over an angular range of at least 90° and preferably over an angular range of 150° to 180°.

The support surface and the fastening flange are preferably designed as a common ring segment. This is approximately L-shaped in (half) cross-section, having a support leg against which rests a peripheral side of the bearing housing, and with a fastening leg via which the screw fastening takes place.

In an expedient configuration, the bearing housing and the at least one fastening foot consist of different materials. By designing the fastening foot as a separate component, the fastening foot on the one hand and the bearing housing on the other hand can be designed for different requirements. Specifically, it is provided that the bearing housing is designed as a forged part and the fastening foot as a cast part. Specifically, in the design as a forged part, directly integrated running surfaces for roller bodies of the bearing are formed on the bearing housing, so that the otherwise usual bearing ring on the housing side is dispensed with.

Two and in particular exactly two fastening feet are preferably provided, which are spaced apart from one another in the direction of the axis of rotation. These two fastening feet are arranged in particular in the area of a respective bearing and therefore support the bearing housing directly in the area of the respective bearing. The two fastening feet are in particular of the same design, in particular they are designed as mirror images of one another, with the possible exception of different diameters. Preferably, both fastening feet therefore each have the features listed above for the at least one fastening foot.

In particular, both fastening feet each have a ring-segment-like fastening flange, which is screwed axially onto an annular flange in each case. In particular, the fastening flange in each case overlaps an end face (end annular flange) of the bearing housing. As a result of this measure, the bearing housing is secured axially in and against the axis of rotation.

In an expedient variant, the at least one fastening foot and preferably all fastening feet are designed as a separate structural unit, which is also independent of the machine support and is connected thereto, specifically screwed, in the fastened state. This means that the at least one fastening foot, in particular both fastening feet, is a completely independent structural unit, which is designed independently of the bearing housing on the one hand and also independently of the machine support and is in particular detachably connected to each of these components, specifically via a screw connection.

In an alternative embodiment variant, the at least one fastening foot is designed as part of the machine support. The machine support and fastening foot form a monolithic component. In this variant with a fastening foot integrated into the machine support, there is therefore no need for a screw connection between the fastening foot and the machine support that would otherwise be required. According to one embodiment, all (both) fastening feet are an integral part of the machine support.

According to a preferred variant, a part (the one) of the fastening feet is an integral part of the machine support and another part (the other) is designed as a separate structural unit. During assembly, the fastening foot, which is designed as a separate structural unit, allows for any tolerance compensation that may be required. A high level of mechanical strength is achieved via the fastening foot, which is designed as an integral part of the machine support.

As already mentioned above, in a preferred embodiment the main bearing unit generally has two offset (tapered roller) bearings spaced apart from one another, and a fastening foot is arranged in the region of each bearing.

### BRIEF DESCRIPTION OF THE DRAWINGS

Exemplary embodiments of the disclosure are explained in more detail below with reference to the figures. In simplified representations:

FIG. 1 shows a view of a main bearing assembly according to a first embodiment and

FIG. 2 shows a view of a main bearing assembly according to a second embodiment.

### DETAILED DESCRIPTION

In the figures, identically acting elements are provided with the same reference symbols.

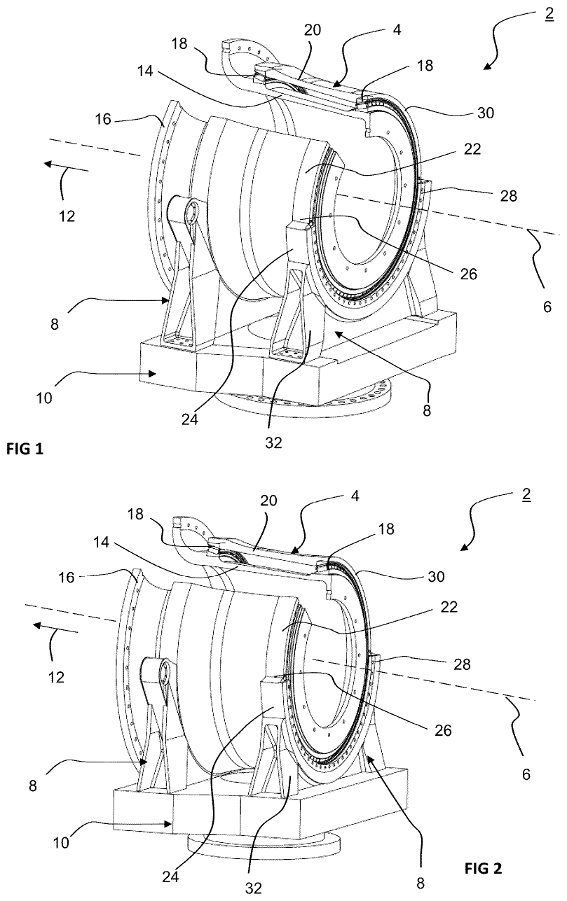

A main bearing assembly 2 is shown in each of FIGS. 1 and 2, which has a main bearing unit 4 which extends along an axis of rotation 6. The main bearing unit 4 is placed on an open machine support 10 via two fastening feet 8 and is fastened thereto. In the exemplary embodiment, the machine support 10 is designed as a flat, plate-shaped machine support 10.

In both figures, the main bearing unit 4 is shown partially cut open only for illustration purposes.

The main bearing assembly 2 and thus also the main bearing unit 4 each extend in a longitudinal direction 12 running parallel to the axis of rotation 6 from a rear, tower-side end to a front, hub-side end. The main bearing unit 4 has a rotor 14 designed as a hollow body, which is shaped into a rotor flange 16 at the hub end. When installed in the wind turbine, a hub, not shown in detail here, with rotor blades fastened thereto is screwed thereinto.

The rotor 14 is mounted on a stator, which is generally referred to as a bearing housing 20, via two bearings 18 which are spaced apart from one another in the longitudinal direction 12. The bearing housing 20 is generally designed as a rotationally symmetrical tube. In the exemplary embodiment, it widens slightly conically in the longitudinal direction 12. The two bearings 18 are, in particular, tapered roller bearings, preferably in an O arrangement. A respective bearing 18 has a plurality of individual tapered rollers, which are typically arranged between an outer ring and an inner ring. The outer ring is arranged on, and in particular fastened to, the bearing housing 20 and the inner ring on the rotor 14. At the tower-side end, the rotor has a further annular flange, with which it is flanged, for example, to a downstream gear unit or a shaft.

The bearing housing 20 has a ring-shaped peripheral counter-bearing surface 22 at each of the two opposite ends thereof. The bearing housing 20 rests with this counter-bearing surface 22 on a respective fastening foot 8.

A respective fastening foot 8 has a ring segment 24 for this purpose, which in the exemplary embodiment extends over approximately 180° and thus forms an approximately semi-annular receptacle for the bearing housing 20. Viewed in partial section, this ring segment 24 preferably has an approximately L-shaped cross-sectional contour with a support leg extending in the longitudinal direction 12, which forms a support surface 26, and with a radially extending fastening leg, which forms a ring-segment-like fastening flange 28.

The bearing housing 20 rests with the counter-bearing surface 22 thereof on the support surface 26 over the entire segment surface thereof. These two surfaces 22, 26 preferably have a similar or identical axial extent. In the exemplary embodiment, the bearing housing 20 is expanded radially in the area of the counter-bearing surface 22 to create space for the bearing 18 arranged at this point. In addition or as an alternative, there is also the possibility that the bearing housing 20 is thickened in the area of the counter-bearing surface 22.

The fastening flange 28 preferably has a large number of screw holes distributed over the circumference thereof, through which screws or other bolts are inserted to fasten the bearing housing 20 to the respective fastening foot 8. These extend axially and connect the fastening flange 28 to an annular flange formed on the bearing housing 20, which in the exemplary embodiment is formed by an end face 30 of the bearing housing 20. The ring-segment-like fastening flange 28 therefore overlaps this end face 30 in the radial direction. This is preferably done on both fastening feet 8, so that the bearing housing 20 is positively secured axially in and against the longitudinal direction 12.

A respective fastening foot 8 also has two opposing support struts 32 which carry the ring segment 24 and preferably form a monolithic component therewith. The two support struts 32 are preferably connected to one another with a rigidifying element, which is in particular plate-shaped. This rigidifying element is also connected to ring segment 24. The entire fastening foot 8 preferably forms a monolithic component.

According to the embodiment variant shown in FIG. 1, a respective fastening foot 8 is designed as a completely independent structural unit, which is connected both to the bearing housing 20 and to the machine support 10, in particular via screw connections. The screw connection with the machine support 10 is made via the support struts 32. For this purpose, they have a fastening plate which is oriented towards the machine support 10 and via which the fastening takes place.

In the embodiment variant according to FIG. 2, the fastening feet 8 and thus the support struts 32 are an integral part of the machine support 10 and therefore preferably form a monolithic component therewith.

The main bearing assembly 2 described here is installed in the installed state in a wind power plant that is not shown in detail here. The main advantage of the described main bearing assembly 2 is that the bearing housing 20 has a very simple design due to the tubular and at least essentially rotationally symmetrical design thereof, and can therefore be provided with little effort. Due to the independent fastening foot 8, different materials can be used for this and the bearing housing 20; specifically, the bearing housing is designed, for example, as a forged tube and the fastening feet 8 as cast parts. Overall, this results in new manufacturing options that can lead to weight and cost reductions. Specifically, for example, at least the outer ring of the bearing 18 is dispensed with, and in the region of the bearing 18 a raceway is directly formed by the bearing housing 20 itself, on which the roller bodies roll. Another advantage is the simple and compact design of the machine support 10. Overall, this results in the combination of a compact machine support 10 with a simple tubular and/or rotationally symmetrical bearing housing 10. An adaptation of the bearing housing 10 to different installation situations, specifically to different machine supports 10, is carried out, for example, only via a special design of the fastening feet 8. Overall, this enables good scalability and, in particular, a type of modular system.

The disclosure is not limited to the exemplary embodiments described above. Rather, other variants of the disclosure can also be derived therefrom by a person skilled in the art without departing from the subject matter of the disclosure. In particular, all of the individual features described in connection with the exemplary embodiment can also be combined with one another in other ways without departing from the subject matter of the disclosure.

### LIST OF REFERENCE SYMBOLS

2 Main bearing assembly
4 Main bearing unit
6 Rotational axis
8 Fastening foot
10 Machine support
12 Longitudinal direction
14 Rotor
16 Rotor flange
18 Bearing
20 Bearing housing
22 Counter bearing surface
24 Ring segment
26 Support surface
28 Ring segment-like fastening flange
30 End face
32 Support strut

1. A main bearing assembly for a wind turbine, the main bearing assembly extending along an axis of rotation, comprising: a main bearing unit with a bearing housing configured for fastening to an open machine support, wherein the bearing housing is rotationally symmetrical and includes at least one fastening foot fastened to the bearing housing, wherein the main bearing unit is installed on the machine support with the aid of the at least one fastening foot.

2. The main bearing assembly according to claim 1, wherein the at least one fastening foot is screwed into the bearing housing.

3. The main bearing assembly according to claim 1, wherein the fastening foot has a fastening flange in the form of a ring segment for fastening to the bearing housing.

4. The main bearing assembly according to claim 3, wherein the bearing housing has an end face and the fastening flange overlaps the end face.

5. The main bearing assembly according to claim 1, wherein the at least one fastening foot has at least one ring-segment-like supporting surface on which the bearing housing rests.

6. The main bearing assembly according to claim 1 wherein the at least one fastening foot and the bearing housing comprise different materials, wherein the bearing housing is a forged part and the fastening foot is a cast part.

7. The main bearing assembly according to claim 1, further comprising at least two fastening feet spaced apart from one another in a direction of the axis of rotation.

8. The main bearing assembly according to claim 1, wherein the at least one fastening foot is at least one of a separate structural unit connected to the machine support in the fastened state, or the at least one fastening foot and the machine support form a common component.

9. The main bearing assembly according to claim 7, wherein a first fastening foot is a separate structural unit and a second fastening foot forms a common component with the machine support.

10. The main bearing assembly according to claim 1, wherein the main bearing unit has two bearings which are spaced apart from one another and a fastening foot is arranged in a region of each bearing.

11. A main bearing assembly for a wind turbine, the main bearing assembly extending along an axis of rotation, comprising:
a main bearing unit with a bearing housing configured for fastening to an open machine support, wherein the bearing housing has a flattened area on a peripheral side defining a fastening surface for fastening to the machine support.

12. The main bearing assembly according to claim 11, wherein the bearing housing is rotationally symmetrical.

13. The main bearing assembly according to claim 11, wherein the flattened area extend over an entire length of the bearing housing.
